(19) United States
(12) Patent Application Publication
(10) Pub. No.: US 2025/0326055 A1
(43) Pub. Date: Oct. 23, 2025

(54) FEED POSITIONING DEVICE, AND LASER LABEL ENGRAVING MACHINE HAVING THE SAME

(71) Applicants: DINKLE ENTERPRISE CO., LTD., New Taipei City (TW); DINKLE ELECTRIC MACHINERY (CHINA) CO., LTD., KUNSHAN (CN); LI YANG ELECTRIC MACHINERY (DONGGUAN) CO., LTD., Dong Guan City (CN)

(72) Inventor: Shang-Tsai WU, New Taipei City (TW)

(21) Appl. No.: 18/638,664

(22) Filed: Apr. 17, 2024

(51) Int. Cl. B23K 26/08

(52) U.S. Cl. CPC B23K 26/083

(57) ABSTRACT

A feed positioning device includes a material preparation table, a working table, a conveying mechanism and a positioning mechanism. The conveying mechanism includes a transmission shaft, a driving motor connected to the transmission shaft, a first and a second driving wheel, a first and a second driven wheel, a first belt hooping the first driving wheel and driven wheel, and a second belt hooping the second driving wheel and driven wheel. The positioning mechanism includes an actuating screw, a first and a second fixture, the actuating screw includes a first and a second threaded section with opposite spiral directions and engaged with the first and second fixture respectively. The transmission shaft includes a longitudinal keyway engaged with the first and second driving wheel, which are respectively connected to the first and the second fixture to move the first and second fixture when the actuating screw is rotated.

### BACKGROUND OF THE DISCLOSURE

### Technical Field

The present disclosure relates to a laser label engraving machine, and more particularly relates to a size-adjustable feed positioning device and a laser label engraving machine having the feed positioning device.

### Related Art

As industry blooms, many factories gradually introduce automated and semi-automated equipment to effectively reduce labor force, increase productivity, and improve yield rate. In the field of automation and semi-automation, it is often necessary to transfer or move materials between stations of different processes, so that the materials will be moved in the form of multiple quantities at a time, such as belts, discs, trays, etc. In order to reduce the material replenishment time, most of the automated and semi-automated equipment have a waiting area set in front of a starting station to store the plurality of materials to be processed, and move the plurality of materials to the processing area to be processed through a conveying mechanism.

In general, a related-art laser label engraving machine generally consists of a feeding device and a laser head, the feeding device puts the material under a laser head and positions the material such that the laser head can process the material. However, the feeding device of the related-art laser label engraving machine is generally designed for a specific size, so that when there is a change of the material, it is necessary to design the new material to a compatible size, or replace the feeding device with a compatible one for the new material.

Therefore, the related-art laser label engraving machines have poor compatibility with materials of different specifications and the drawbacks of being inconvenient to use and unsuitable for small-volume label engraving.

In view of this problem, the present discloser has focused on the above drawbacks of the related art to conduct extensive research and experiment and overcome the above-mentioned problem.

### SUMMARY OF THE DISCLOSURE

The primary objective of the present disclosure is to provide a size-adjustable feed positioning device and a laser label engraving machine with the feed positioning device.

To achieve the aforementioned objective, the present disclosure provides a feed positioning device for conveying a plurality of materials, which includes a material preparation table, a working table, a conveying mechanism and a positioning mechanism. material preparation table for carrying the materials. The conveying mechanism includes a transmission shaft, a driving motor connected to the transmission shaft, a first driving wheel and a second driving wheel coaxially installed to the transmission shaft, a first driven wheel and a second driven wheel coaxially installed, a first belt wound around the first driving wheel and the first driven wheel and connected between the material preparation table and the working table, and a second belt wound around the second driving wheel and the second driven wheel and connected between the material preparation table and the working table, The driving motor drives the transmission shaft to rotate the first driving wheel and the second driving wheel to push the first belt and the second belt to move forward, and one of the materials is carried by the first belt and the second belt and conveyed to the working table. The positioning mechanism is installed to the working table and the positioning mechanism includes an actuating screw, a first fixture and a second fixture, the actuating screw has a first threaded section and a second threaded section with opposite spiral directions, the first fixture is engaged with a first bolt of the first threaded section, the second fixture is engaged with a second bolt of the second threaded section, the material conveyed to the working table is positioned between the first fixture and the second fixture. A side of the transmission shaft is provided with a longitudinal keyway, the first driving wheel is connected to the first fixture, and the first driving wheel has a first sliding key engaged with the longitudinal keyway and linked with the transmission shaft, the second driving wheel is connected to the second fixture, the second driving wheel has a second sliding key engaged with the longitudinal keyway and linked with the transmission shaft. When the actuating screw is rotated, the first threaded section and the second threaded section respectively drive the first bolt and the second bolt to move relatively near to or away from each other.

In an embodiment of the present disclosure, the actuating screw is equipped with a rotating handle.

In an embodiment of the present disclosure, the first driven wheel is pivotally installed to the first fixture, and the second driven wheel is pivotally installed to the second fixture.

In an embodiment of the present disclosure, the first threaded section and the second threaded section extend from the middle section of the actuating screw to two ends of the actuating screw respectively.

In an embodiment of the present disclosure, the first driving wheel and the second driving wheel are configured to be corresponsive to one of the material preparation table and the working table, the first driven wheel and the second driven wheel are configured to be corresponsive to another one of the material preparation table and the working table.

In an embodiment of the present disclosure, the first belt and second belt is installed between the first fixture and the second fixture.

The present disclosure further provides a laser label engraving machine for conveying a plurality of materials, the laser label engraving machines includes a main body, a material preparation table, a working table, a conveying mechanism, a positioning mechanism and a laser head. The material preparation table is mounted on the main body and provided for carrying the materials. The working table is mounted on the main body. The conveying mechanism is provided for conveying one of the materials to the working table, and the conveying mechanism includes a transmission shaft, a driving motor connected to the transmission shaft, a first driving wheel and a second driving wheel coaxially installed to the transmission shaft, a first driven wheel and a second driven wheel coaxially installed, a first belt wound around the first driving wheel and the first driven wheel and connected between the material preparation table and the working table, and a second belt wound around the second driving wheel and the second driven wheel and connected between the material preparation table and the working table. The driving motor drives the transmission shaft to drive and rotate the first driving wheel and the second driving wheel to push the first belt and the second belt forward. The material is carried by the first belt and the second belt and conveyed to the working table. The positioning mechanism is configured on the working table, and the positioning mechanism includes an actuating screw, a first fixture and a second fixture, the actuating screw includes a first threaded section and a second threaded section with opposite spiral directions, the first fixture includes a first bolt engaged with the first threaded section, the second fixture includes a second bolt engaged with the second threaded section, and the material conveyed to the working table is positioned between the first fixture and the second fixture. The laser head is installed to the main body, configured above the working table, and provided for engraving the aligned material to be engraved on the working table. A side of the transmission shaft is provided with a longitudinal keyway, the first driving wheel is connected to the first fixture and the first driving wheel includes a first sliding key engaged with the longitudinal keyway and linked to the transmission shaft, and a second driving wheel is connected to the second fixture and engaged with the second driving wheel and the second driving wheel includes a second sliding key engaged with the longitudinal keyway and linked to the transmission shaft, such that when the actuating screw is rotated, the first threaded section and the second threaded section drive the first bolt and the second bolt respectively to move relatively close to or away from each other.

In an embodiment of the present disclosure, the actuating screw is equipped with a rotating handle.

In an embodiment of the present disclosure, the first driven wheel is pivotally installed to the first fixture, and the second driven wheel is pivotally installed to the second fixture.

In an embodiment of the present disclosure, the first threaded section and the second threaded section extend from the middle section of the actuating screw to two ends of the actuating screw respectively.

In an embodiment of the present disclosure, the first driving wheel and the second driving wheel are configured to be corresponsive to one of the material preparation table and the working table, and the first driven wheel and the second driven wheel are configured to be corresponsive to another one of the material preparation table and the working table.

In an embodiment of the present disclosure, the first belt and the second belt are installed between the first fixture and the second fixture.

The feed positioning device of the laser label engraving machine in accordance with the present disclosure has a positioning mechanism of variable size, and the positioning mechanism is capable of moving on the conveying mechanism to change the size in order to fit different sized materials, and the operation of the conveying mechanism may not be affected by the operation of the positioning mechanism.

### BRIEF DESCRIPTION OF THE DRAWINGS

FIG. 1 is a perspective view of a laser label engraving machine in accordance with the present disclosure;

FIG. 2 is a perspective view of a laser label engraving machine with a feed positioning device in accordance with the present disclosure;

FIG. 3 is a partial exploded view of a laser label engraving machine in accordance with the present disclosure;

FIG. 4 is a schematic view showing a using status of a feed positioning device in accordance with the present disclosure;

FIG. 5 is a partially cross-sectional view of a laser label engraving machine in accordance with the present disclosure;

FIG. 6 is a cross-sectional view of Section 6-6 as depicted in FIG. 5; and

FIGS. 7 and 8 are schematic views showing another using status of a feed positioning device in accordance with the present disclosure.

### DETAILED DESCRIPTION

In the description of this disclosure, it should be understood that the terms “front”, “rear”, “left”, “right”, “front end”, “rear end”, “end”, “longitudinal”, “lateral”, “vertical”, “top”, “bottom” and so on refer to an indicated orientation and a positional relation based on the orientation and positional relation as shown in the attached drawings. These terms are used for the purpose of describing the creation of this disclosure and simplifying the description, but not intended for indicating or implying that the device or component must have the specific position, the specific positional structure and operation, so that these terms should not be construed as a limitation on this disclosure.

As used herein and not otherwise defined, the terms “substantially” and “approximately” are used to describe and narrate small changes. When combined with an event or situation, the terms can include the exact moment of the occurrence of the event or situation and the approximate point of proximity of the event or situation. For example, when the terms are combined with a numerical value, the terms can include a range of change smaller than or equal to ±10% of the numerical value, such as smaller than or equal to ±5%, smaller than or equal to ±4%, smaller than or equal to ±3%, smaller than or equal to ±2%, smaller than or equal to ±1%, smaller than or equal to ±0.5%, smaller than or equal to ±0.1%, or smaller than or equal to ±0.05%.

The technical contents of the present disclosure will become apparent from the following detailed description of the preferred embodiments with reference to the accompanying drawings. It is intended that the embodiments and drawings disclosed herein are to be considered illustrative rather than restrictive.

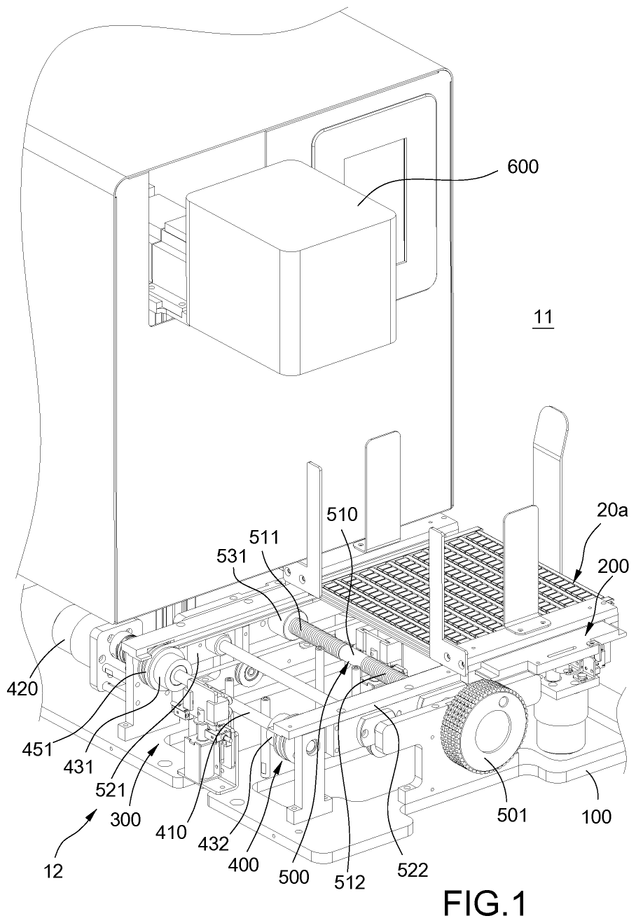

With reference to FIG. 1 for the perspective view of a laser label engraving machine 11 in accordance with an embodiment of the present disclosure, the laser label engraving machine 11 is used for continuously inputting a plurality of materials 20a and engraving labels on the materials 20a by laser beam. In this embodiment, the laser label engraving machine 11 includes a main body 100, a feed positioning device 12 and a laser head 600. In some embodiments, the feed positioning device 12 includes a material preparation table 200, a working table 300, a conveying mechanism 400 and a positioning mechanism 500.

The material preparation table 200 is mounted on the main body 100 and provided for carrying the materials 20a, the materials 20a are stacked and placed on the material preparation table 200. The working table 300 is mounted on the main body 100 and provided for performing laser engraving operations. The conveying mechanism 400 is provided for conveying one of the materials 20a on the material preparation table 200 to the working table 300. In this embodiment, the material 20a stacked at the bottom is outputted from the material preparation table 200 to the working table 300.

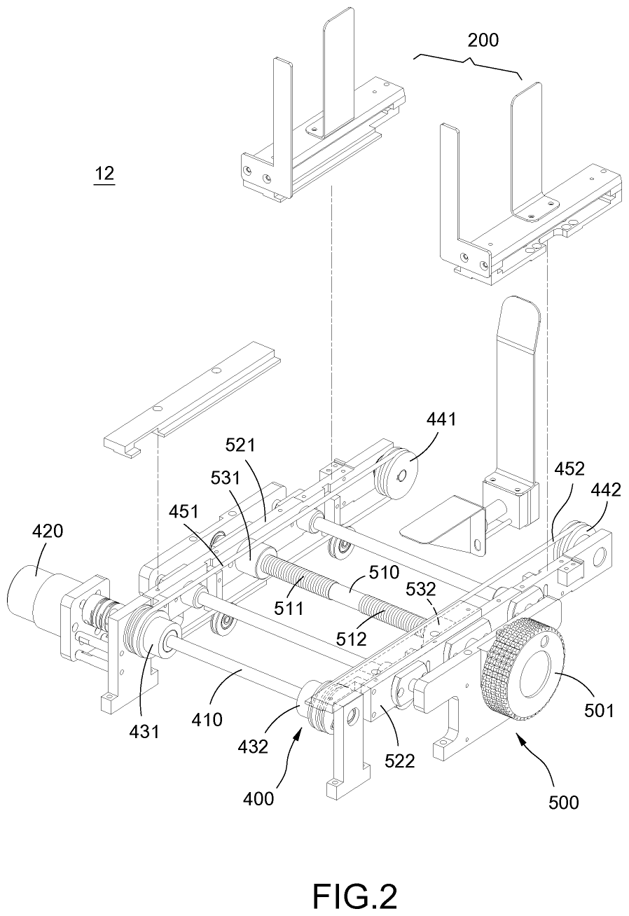

With reference to FIGS. 2 to 4 for some embodiments of the present disclosure, the conveying mechanism 400 includes a transmission shaft 410, a driving motor 420, a first driving wheel 431, a second driving wheel 432, a first driven wheel 441, a second driven wheel 442, a first belt 451 and a second belt 452. The driving motor 420 is connected to the transmission shaft 410, and a side of the transmission shaft 410 is provided with a longitudinal keyway 411. The first driving wheel 431 and the second driving wheel 432 are coaxially installed to the transmission shaft 410. In some embodiments, the transmission shaft 410 is connected in series with the first driving wheel 431 and the second driving wheel 432, the first driving wheel 431 contains a first sliding sleeve 435 and the first sliding sleeve 435 sheathes the transmission shaft 410, the second driving wheel 432 contains a second sliding sleeve 436 and the first sliding sleeve 436 sheathes the transmission shaft 410.

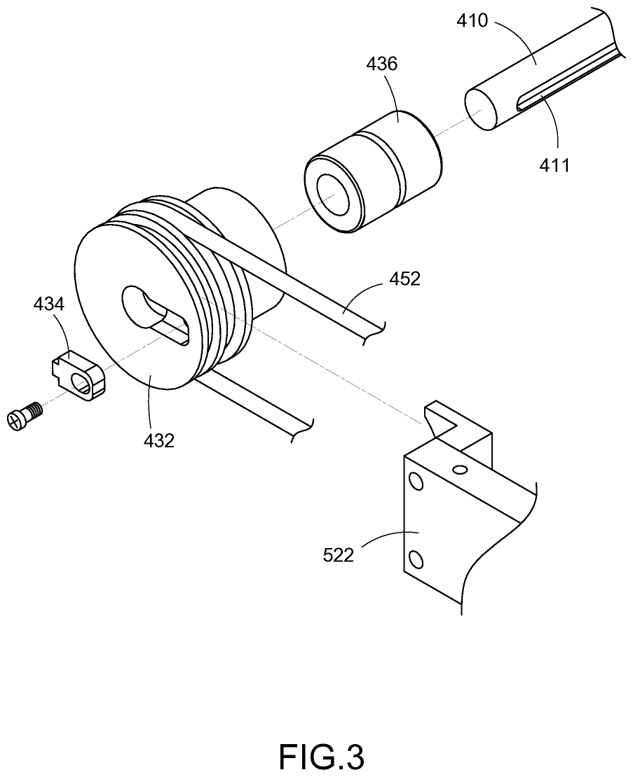

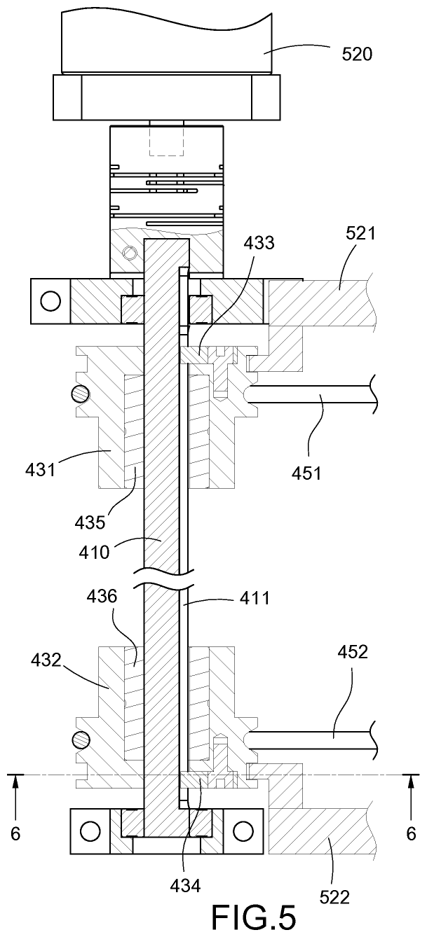

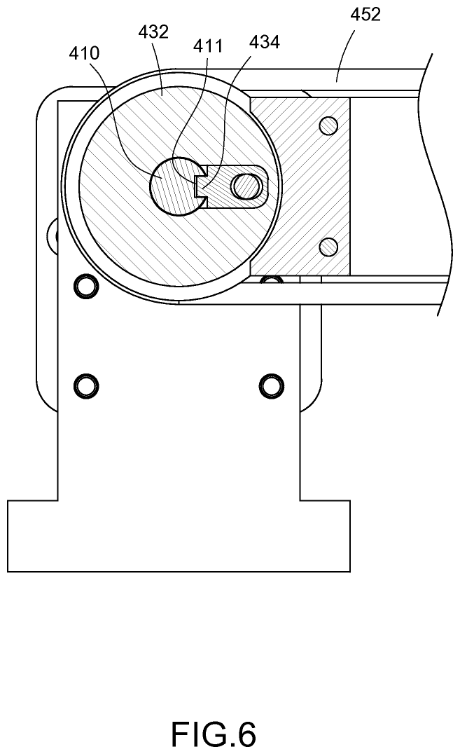

In FIGS. 3 to 6, the first driving wheel 431 includes a first sliding key 433 engaged with the longitudinal keyway 411, such that the first driving wheel 431 links the transmission shaft 410. The second driving wheel 432 includes a second sliding key 434 engaged with the longitudinal keyway 411 and linked to the transmission shaft 410, such that the second driving wheel 432 links the transmission shaft 410.

In FIGS. 1 and 2, the first driven wheel 441 and the second driven wheel 442 are coaxially installed with each other. In some embodiments, the first driving wheel 431 and the second driving wheel 432 are arranged corresponding to one of the material preparation table 200 and the working table 300, and the first driven wheel 441 and the second driven wheel 442 are arranged corresponding to another one of the material preparation table 200 and working table 300. The first belt 451 is wound around the first driving wheel 431 and the first driven wheel 441 and connected between the material preparation table 200 and the working table 300, the second belt 452 is wound around the second driving wheel 432 and the second driven wheel 442 and connected between the material preparation table 200 and the working table 300. The first belt 451 and the second belt 452 are arranged parallelly to each other and extended below the material preparation table 200 respectively to touch the material 20a stacked at the bottom. The driving motor 420 drives the transmission shaft 410 to rotate the first driving wheel 431 and the second driving wheel 432, such that when the first driving wheel 431 and the second driving wheel 432 are rotated, the first belt 451 and the second belt 452 are driven to move forward, and the material 20a stacked at the bottom is carried on the first belt 451 and the second belt 452 and conveyed to the working table 300 by the first belt 451 and the second belt 452.

In FIGS. 1, 2 and 4, the positioning mechanism 500 is arranged on the working table 300, and the positioning mechanism 500 includes an actuating screw 510, a first fixture 521 and a second fixture 522. A side of the actuating screw 510 is provided with a first threaded section 511 and a second threaded section 512 in opposite spiral directions, and the first threaded section 511 and the second threaded section 512 respectively extend from the middle section of the actuating screw 510 to two ends of the actuating screw 510.

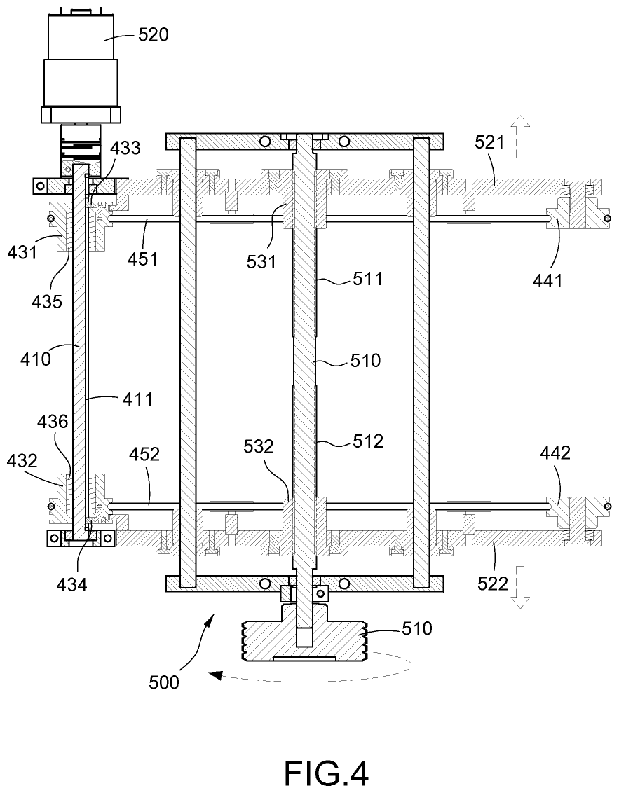

In FIGS. 2 and 4, the first fixture 521 includes a first bolt 531 engaged with the first threaded section 511, the second fixture 522 includes a second bolt 532 engaged with the second threaded section 512, and the material 20a conveyed to the working table 300 is positioned between the first fixture 521 and the second fixture 522.

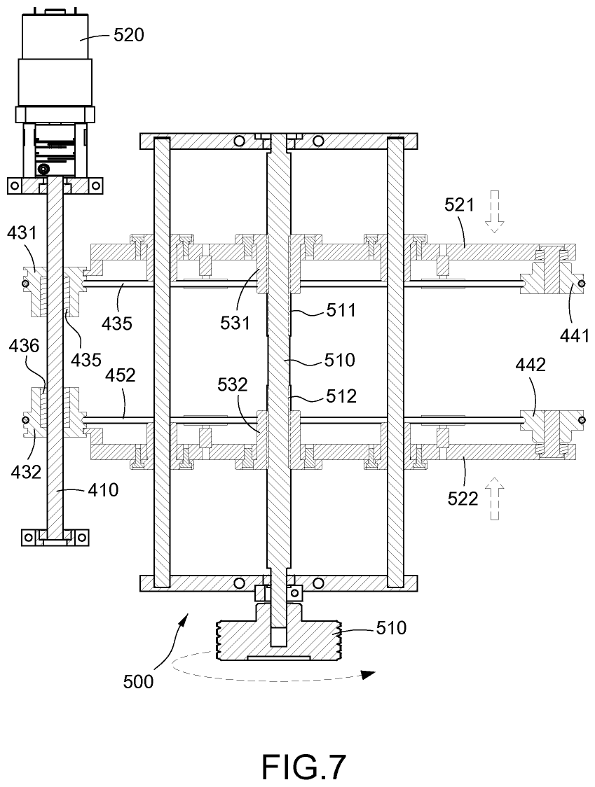

In FIGS. 4 and 7, the actuating screw 510 includes a rotating handle 501 provided for an operator to rotate the actuating screw 510. When the actuating screw 510 is rotated, the first threaded section 511 and the second threaded section 512 respectively drive the first bolt 531 and the second bolt 532 to move relatively close to or far from each other, so as to adjust the distance between the first fixture 521 and the second fixture 522 to fit the size of the inputted material 20a.

The first belt 451 and the second belt 452 are arranged between the first fixture 521 and the second fixture 522. Therefore, the first fixture 521 and the second fixture 522 carry and convey the material 20a, and the first fixture 521 and the second fixture 522 are positioned at the outer edge of the material 20a. The first driving wheel 431 is connected to the first fixture 521 and the first driven wheel 441 is pivotally installed to the first fixture 521. In some embodiments, the first fixture 521 is engaged with the first driving wheel 431, so that the first belt 451 and the first fixture 521 move synchronously. The second driving wheel 432 is connected to the second fixture 522 and the second driven wheel 442 is pivotally installed to the second fixture 522. In some embodiments, the second fixture 522 is engaged with the second driving wheel 432, so that the second belt 452 and the second fixture 522 move synchronously.

In FIG. 1, the laser head 600 is installed to the main body 100 and arranged above the working table 300. The laser head 600 emits a laser beam downward to engrave the material 20a aligned on the working table 300.

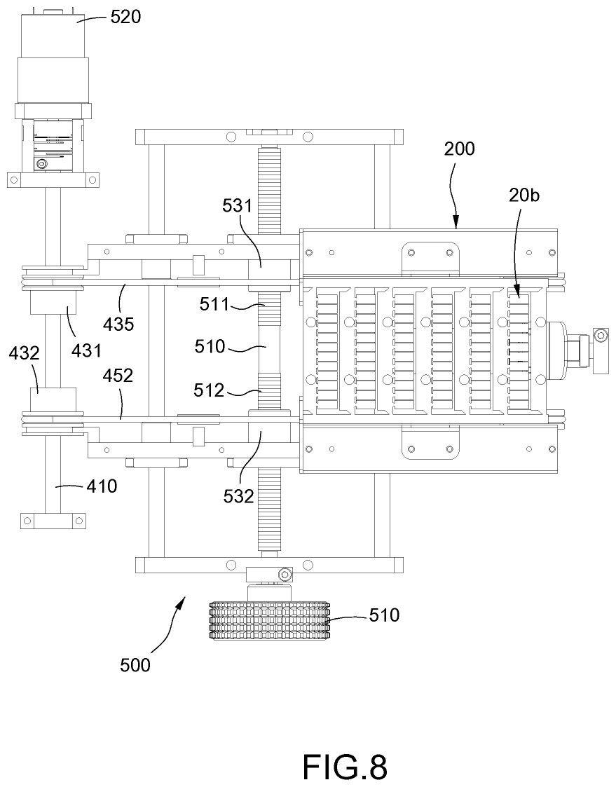

In FIGS. 1 and 8, the feed positioning device 12 of the laser label engraving machine 11 in accordance with the present disclosure has a positioning mechanism 500 of variable size, and its positioning mechanism 500 is capable of moving on the conveying mechanism 400 to change the size in order to fit different sized materials 20a, 20b, and the operation of the conveying mechanism 400 may not be affected by the operation of the positioning mechanism 500.

While the present disclosure is illustrated by exemplary embodiments, there may be numerous other embodiments of the present disclosure, a person skilled in the art may make various corresponding changes and variations in accordance with the present disclosure without departing from the spirit of the present disclosure, but these corresponding changes and variations shall fall within the scope of protection of the patents applied for in the present disclosure.

What is claimed is:

1. A feed positioning device, for conveying a plurality of materials, the feed positioning device comprising:
a material preparation table, configured to carry the materials;
a working table;
a conveying mechanism, comprising a transmission shaft, a driving motor coupled to the transmission shaft, a first driving wheel and a second driving wheel coaxially installed on the transmission shaft, a first driven wheel and a second driven wheel coaxially installed with each other, a first belt wound around the first driving wheel and the first driven wheel to be coupled between the material preparation table and the working table, and a second belt wound around the second driving wheel and the second driven wheel to be coupled between the material preparation table and the working table, wherein the driving motor is configured to drive the transmission shaft to drive and rotate the first driving wheel and the second driving wheel to drive the first belt and the second belt, and one of the materials is carried and conveyed by the first belt and the second belt to the working table; and
a positioning mechanism, disposed on the working table, and comprising an actuating screw, a first fixture and a second fixture, the actuating screw comprising a first threaded section and a second threaded section, a spiral direction of the first threaded section and a spiral direction of the second threaded section opposite to each other, the first fixture comprising a first bolt engaged with the first threaded section, the second fixture comprising a second bolt engaged with the second threaded section, wherein the material conveyed to the working table is positioned between the first fixture and the second fixture, the transmission shaft comprises a longitudinal keyway disposed on one side thereof, the first driving wheel is coupled to the first fixture and comprises a first sliding key engaged with the longitudinal keyway and linked to the transmission shaft, the second driving wheel is coupled to the second fixture and comprises a second sliding key engaged with the longitudinal keyway and linked to the transmission shaft, when the actuating screw is rotated, the first threaded section and the second threaded section respectively drive the first bolt and the second bolt to move close to or away from each other relatively.

2. The feed positioning device according to claim 1, wherein the actuating screw comprises a rotating handle disposed thereon.

3. The feed positioning device according to claim 1, wherein the first driven wheel is pivotally installed to the first fixture, and the second driven wheel is pivotally installed to the second fixture.

4. The feed positioning device according to claim 1, wherein the first threaded section and the second threaded section extend from a middle section of the actuating screw to two ends of the actuating screw respectively.

5. The feed positioning device according to claim 1, wherein the first driving wheel and the second driving wheel are arranged corresponding to one of the material preparation table and the working table, and the first driven wheel and the second driven wheel are arranged corresponding to another one of the material preparation table and the working table.

6. The feed positioning device according to claim 1, wherein the first belt and the second belt are installed between the first fixture and the second fixture.

7. A laser label engraving machine, for conveying a plurality of materials, the laser label engraving machine comprising:
a main body;
a material preparation table, installed to the main body, configured to carry the materials;
a working table, installed to the main body;
a conveying mechanism, configured to convey one of the materials to the working table, comprising a transmission shaft, a driving motor coupled to the transmission shaft, a first driving wheel and a second driving wheel coaxially installed on the transmission shaft, a first driven wheel and a second driven wheel coaxially installed with each other, a first belt wound around the first driving wheel and the first driven wheel to be coupled between the material preparation table and the working table, and a second belt wound around the second driving wheel and the second driven wheel to be coupled between the material preparation table and the working table, wherein the driving motor is configured to drive the transmission shaft to drive and rotate the first driving wheel and the second driving wheel to drive the first belt and the second belt, and the material is carried and conveyed by the first belt and the second belt to the working table;
a positioning mechanism, arranged on the working table, and comprising an actuating screw, a first fixture and a second fixture, the actuating screw comprising a first threaded section and a second threaded section, a spiral direction of the first threaded section and a spiral direction of the second threaded section opposite to each other, the first fixture comprising a first bolt engaged with the first threaded section, the second fixture comprising a second bolt engaged with the second threaded section, wherein the material conveyed to the working table is positioned between the first fixture and the second fixture;
a laser head, configured to engrave the material aligned on the working table, installed on the main body, and arranged above the working table, the transmission shaft comprising a longitudinal keyway disposed on one side thereof, wherein the first driving wheel is coupled to the first fixture and comprises a first sliding key engaged with the longitudinal keyway and linked to the transmission shaft, the second driving wheel is coupled to the second fixture and comprises a second sliding key engaged with the longitudinal keyway and linked to the transmission shaft, when the actuating screw is rotated, the first threaded section and the second threaded section respectively drive the first bolt and the second bolt to move close to or away from each other relatively.

8. The feed positioning device according to claim 7, wherein the actuating screw comprises a rotating handle disposed thereon.

9. The feed positioning device according to claim 7, wherein the first driven wheel is pivotally installed to the first fixture, and the second driven wheel is pivotally installed to the second fixture.

10. The feed positioning device according to claim 7, wherein the first threaded section and the second threaded section extend from a middle section of the actuating screw to two ends of the actuating screw respectively.

11. The feed positioning device according to claim 7, wherein the first driving wheel and the second driving wheel are arranged corresponding to one of the material preparation table and the working table, and the first driven wheel and the second driven wheel are arranged corresponding to another one of the material preparation table and the working table.

12. The feed positioning device according to claim 7, wherein the first belt and the second belt are installed between the first fixture and the second fixture.
